(19) United States
(12) Patent Application Publication
(10) Pub. No.: US 2019/0330565 A1
(43) Pub. Date: Oct. 31, 2019

(54) DETERGENT COMPOSITIONS CONTAINING COPOLYMER

(71) Applicant: Clariant International Ltd., Muttenz (CH)

(72) Inventors: Kevin James MUTCH, Frankfurt (DE); Natascha SCHELERO, Hattersheim (DE); Dorothee GABEL, Wiesbaden (DE)

(73) Assignee: Clariant International Ltd., Muttenz (CH)

(21) Appl. No.: 16/462,915

(22) PCT Filed: Nov. 21, 2017
(86) PCT No.: PCT/EP2017/079956

§ 371 Date: May 21, 2019

(30) Foreign Application Priority Data
Nov. 28, 2016 (DE) 102016223584.2

(51) Int. Cl. C11D 3/00; C11D 3/37; C11D 1/14; C11D 1/22; C11D 1/72; C11D 1/66; C11D 1/75; C11D 1/62

(52) U.S. Cl. CPC C11D 3/0036; C11D 3/3776; C11D 3/3769; C11D 3/3757; C11D 1/62; C11D 1/22; C11D 1/72; C11D 1/662; C11D 1/75; C11D 1/146

(57) ABSTRACT

What are described are laundry detergent compositions comprising one or more copolymers containing cationic structural units and macromonomeric structural units, and also one or more surfactants. The copolymers are advantageously notable as soil release polymers in the laundry detergent composition for use on cotton.

The present invention relates to laundry detergent compositions comprising copolymers (polymer additives) containing one or more cationic structural units and one or more macromonomeric structural units, and to the use of the laundry detergent compositions or of the copolymers for cleaning textiles, preferably cotton-containing textiles, or for reducing the restaining of textiles, preferably of cotton-containing textiles, on which the laundry detergent compositions or the copolymers have been employed. The copolymers present in the laundry detergent compositions of the invention can thus function as soil release polymers, especially when used on cotton-containing textiles.

On washing with standard domestic laundry detergent compositions, particular contaminations can be removed from the fiber only with difficulty either because they adhere strongly on the fiber or penetrate deep into the fiber interstices. Therefore, the use of soil release polymers in laundry detergent compositions is customary. It is assumed that soil release polymers are deposited on the fiber, and alter the surface properties thereof in such a way that soil can be more readily detached from the fiber. What are typically used for predominantly polyester-based textiles are derivatives of polymers of terephthalic acid and polyethylene glycol (e.g. E. P. Gosselink, “Soil Release Agents in Powdered Detergents”, ch. 7 (pp. 205-239) in Surfactant Science Series 71, “Powdered Detergents”).

While distinct detachment of soil is achieved by the addition of soil release polymers for the cleaning of polyester-based textiles, the detachment of greasy stains from cotton is less well understood and therefore more difficult.

WO 97/42293 describes a laundry detergent formulation comprising water-soluble or water-dispersible polyamines having a functionalized polymer backbone, which imparts soil release properties to cotton.

EP 0936224 describes water-soluble or water-dispersible polymers bearing polysaccharide units. One use described is that in laundry detergent compositions.

WO 01/88075 discloses the use of anionically modified polysaccharides which, in laundry detergent compositions, assure better detachment of oily or greasy stains on cotton.

EP 1972683 describes ampholytic water-soluble polymers which, in laundry detergent composition, protect the fibers from oily or greasy soils.

U.S. Pat. No. 7,160,947 describes graft copolymers having soil release properties in laundry detergent compositions. These polymers preferably have 2-dimethylaminoethyl (meth)acrylate side chains, polyethylene oxide (meth)acrylate side chains, and are obtained by means of free-radical polymerization.

WO 2015/078736 describes polymers which contain hydrophilic side chains based on polyethylene oxide and 2-dimethylaminoethyl (meth)acrylate and assure improved soil release properties in laundry detergent formulations.

WO 2013/060708 uses comb copolymers or block copolymers as graying inhibitors and soil release polymers, including on cotton.

Even though these systems already lead to improved detachment of soil, there continues to be room for improvement. It is often the case that the active substances from the prior art are not absorbed in an adequate amount onto textile fibers and especially onto cotton-containing textile fibers, and so the soil release effect of these active substances is often unsatisfactory.

It was an object of the present invention to develop polymer additives that are water-soluble or water-dispersible and can be added to laundry detergent compositions, with the result that they can be absorbed onto cotton, and an advantageous soil release effect can be observed on cotton.

It has been found that, surprisingly, this object can be achieved by laundry detergent compositions comprising

Z1) one or more copolymers containing
a) 0.1 to 99.9 mol %, preferably 10.0 to 85.0 mol % and more preferably 10.0 to 82.0 mol % of one or more cationic structural units (A) and
b) 0.1 to 99.9 mol %, preferably 15.0 to 90.0 mol % and more preferably 18.0 to 90.0 mol % of one or more macromonomeric structural units (B),

wherein the one or more cationic structural units (A) are represented by the following formulae (I) and/or (II):

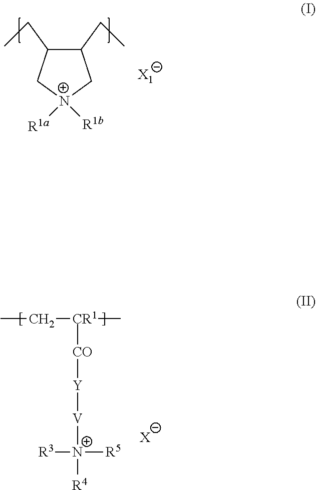

in which
R¹ and R^{1a} are each the same or different and are each independently hydrogen and/or a methyl radical,
R^{1b}, R³, R⁴ and R⁵ are each the same or different and are each independently represented by hydrogen, an aliphatic hydrocarbyl radical having 1 to 20 and preferably 1 to 4 carbon atoms, a cycloaliphatic hydrocarbyl radical having 5 to 20 and preferably 5 to 8 carbon atoms, an aryl radical having 6 to 14 carbon atoms and/or polyethylene glycol (PEG), are preferably each the same or different and are each independently represented by hydrogen and/or methyl and are more preferably each methyl,
Y is the same or different and is represented by oxygen, NH and/or NR³,
V is the same or different and is represented by —(CH₂)ₓ—,

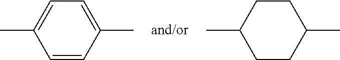

x is the same or different and is represented by an integer from 1 to 6,
X and X₁ are each the same or different and are each independently represented by a halogen atom, C₁- to C₄-alkylsulfate and/or C₁- to C₄-alkylsulfonate,

and the one or more macromonomeric structural units (B) are represented by the formula (III):

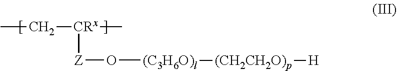

in which
R^{x} is the same or different and is represented by H and/or methyl,
Z is the same or different and is represented by C═O and/or O(CH₂)₄,
l on molar average is a number from 0 to 6 and preferably from 0 to 5, and
p on molar average is a number from 1 to 150, preferably from 11 to 100 and more preferably from 12 to 50,

and

Z2) one or more surfactants.

The invention therefore provides laundry detergent compositions comprising

Z1) one or more copolymers containing
a) 0.1 to 99.9 mol %, preferably 10.0 to 85.0 mol % and more preferably 10.0 to 82.0 mol % of one or more cationic structural units (A) and
b) 0.1 to 99.9 mol %, preferably 15.0 to 90.0 mol % and more preferably 18.0 to 90.0 mol % of one or more macromonomeric structural units (B),

wherein the one or more cationic structural units (A) are represented by the following formulae (I) and/or (II):

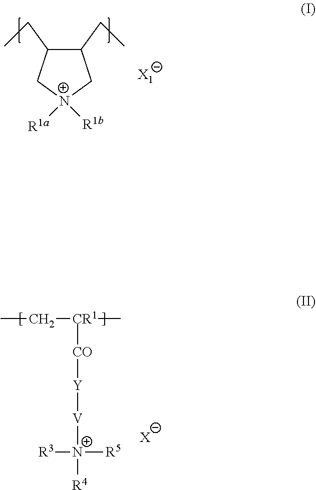

in which
R¹ and R^{1a} are each the same or different and are each independently hydrogen and/or a methyl radical,
R^{1b}, R³, R⁴ and R⁵ are each the same or different and are each independently represented by hydrogen, an aliphatic hydrocarbyl radical having 1 to 20 and preferably 1 to 4 carbon atoms, a cycloaliphatic hydrocarbyl radical having 5 to 20 and preferably 5 to 8 carbon atoms, an aryl radical having 6 to 14 carbon atoms and/or polyethylene glycol (PEG), are preferably each the same or different and are each independently represented by hydrogen and/or methyl and are more preferably each methyl,
Y is the same or different and is represented by oxygen, NH and/or NR³
V is the same or different and is represented by —(CH₂)ₓ—,

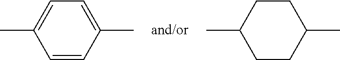

x is the same or different and is represented by an integer from 1 to 6,
X and X₁ are each the same or different and are each independently represented by a halogen atom, C₁- to C₄-alkylsulfate and/or C₁- to C₄-alkylsulfonate,

and the one or more macromonomeric structural units (B) are represented by the formula (III):

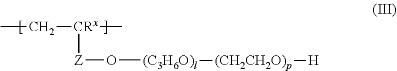

in which
R^{x} is the same or different and is represented by H and/or methyl,
Z is the same or different and is represented by C═O and/or O(CH₂)₄,
l on molar average is a number from 0 to 6 and preferably from 0 to 5, and
p on molar average is a number from 1 to 150, preferably from 11 to 100 and more preferably from 12 to 50,

and

Z2) one or more surfactants.

The laundry detergent compositions of the invention may be in liquid form or in powder form under standard conditions (25° C., 1 atmosphere (1 atm)).

One advantage of the invention is that the copolymers of component Z1) of the laundry detergent compositions of the invention can easily be prepared synthetically and in water, which is an environmentally friendly solvent. A further advantage of the invention is that the copolymers of component Z1) of the laundry detergent compositions of the invention can be formulated in standard laundry detergent compositions because they are water-soluble. Moreover, they have a high affinity for cotton, but without functioning as a soil magnet. Textiles which are pretreated with the laundry detergent compositions of the invention can be more easily freed of greasy stains. The laundry detergent compositions of the invention or the copolymers of component Z1) present therein protect textiles and especially cotton textiles from soil in an advantageous manner, and lead to a very advantageous cleaning performance.

WO 2012/076365 A1 discloses cationic copolymers containing cationic structural units and macromonomeric structural units, and the use thereof as additive for building material systems, especially based on calcium sulfate.

WO 2008/049549 A2 describes hydrophobically modified cationic copolymers having at least three different structural units, one structural unit of which has a terminal phenyl group or specifically substituted phenyl group. With the aid of the copolymers, especially in combination with anionic surfactants, even in the case of high salt burdens, it is possible to achieve a considerable improvement in water retention in aqueous building material systems based on hydraulic binders such as cement.

WO 2008/141844 A1 describes dispersions comprising inorganic particles, water and at least one water-soluble polymer. The at least one water-soluble polymer has repeat units derived from monomers having at least one quaternary ammonium group, repeat units derived from monomers having at least one carboxyl group, and repeat units derived from polyoxyalkylene group-containing ester monomers having a number-average molecular weight in the range from 3000 g/mol to 10 000 g/mol. The dispersions can especially be used for production of concrete and can be processed over a very long period of time.

WO 2008/046652 A1 describes graft polymers obtainable by copolymerization of at least one specific macromonomer and at least one further monomer having a polymerizable ethylenically unsaturated double bond, and the use thereof as dispersants, for example in pigment concentrates.

US 2011/0144264 A1 describes the use of substances such as polyethylene glycol (meth)acrylates or poly(ethylene-co-propylene) glycol (meth)acrylates, for example, which, during the process of latex production, can contribute to stabilization through emulsion polymerization of at least one polymerizable monomer.

JP 2008-056711 A discloses copolymers which have a number-average molecular weight of 5000 to 1 000 000 and contain structural units which are formed by polymerization of particular cationic monomers, polyoxyalkylene-modified monomers and crosslinkable monomers, and which may additionally contain further structural units which are formed by polymerization of further monomers that can be copolymerized with the aforementioned monomers. The copolymers can be used, for example, as antistats for thermoplastic polymers.

Preferably, the one or more cationic structural units (A) of the one or more copolymers of component Z1) of the laundry detergent compositions of the invention is/are the polymerization product of at least one monomer species selected from the group consisting of [2-(acryloyloxy)ethyl]trimethylammonium chloride, [2-(acryloylamino)ethyl]trimethylammonium chloride, [2-(acryloyloxy)ethyl]trimethylammonium methosulfate, [2-(methacryloyloxy)ethyl]trimethylammonium chloride or methosulfate, [3-(acryloylamino)propyl]trimethylammonium chloride, [3-(methacryloylamino)propyl]trimethylammonium chloride and diallyldimethylammonium chloride (DADMAC),

the one or more cationic structural units (A) of the one or more copolymers of component Z1) of the laundry detergent compositions of the invention more preferably being the polymerization product of at least one monomer species selected from the group consisting of [3-(acryloylamino)propyl]trimethylammonium chloride, [3-(methacryloylamino)propyl]trimethylammonium chloride and diallyldimethylammonium chloride, and

the one or more cationic structural units (A) of the one or more copolymers of component Z1) of the laundry detergent compositions of the invention especially preferably being the polymerization product of at least one monomer species selected from the group consisting of [3-(methacryloylamino)propyl]trimethylammonium chloride and [3-(acryloylamino)propyl]trimethylammonium chloride.

Preferably, the one or more macromonomeric structural units (B) of the formula (III) of the one or more copolymers of component Z1) of the laundry detergent compositions of the invention are the polymerization product of at least one monomer species selected from the group consisting of polyethylene glycol vinyloxybutyl ether, polyethylene glycol-co-polypropylene glycol vinyloxybutyl ether (in which I on molar average is a number from 1 to 6, preferably from 1 to 5 and more preferably from 2 to 5), polyethylene glycol (meth)acrylate and polyethylene glycol-co-polypropylene glycol (meth)acrylate (in which I on molar average is a number from 1 to 6, preferably from 1 to 5 and more preferably from 2 to 5).

In the context of the present invention, the expression “(meth)acrylate” encompasses both the corresponding acrylate compound and the corresponding methacrylate compound.

More preferably, in the one or more macromonomeric structural units (B) of the formula (III) of the one or more copolymers of component Z1) of the laundry detergent compositions of the invention,
i) R^{x} is H, I=0 and p on molar average is a number from 1 to 150, preferably from 11 to 100 and more preferably from 12 to 50 when Z is O(CH₂)₄ or
ii) R^{x} is the same or different and is represented by H and/or methyl, I on molar average is a number from 1 to 6, preferably from 1 to 5 and more preferably from 2 to 5, and p on molar average is a number from 1 to 150, preferably from 11 to 100 and more preferably from 12 to 50 when Z is C═O.

Especially preferably, the one or more copolymers of component Z1) of the laundry detergent compositions of the invention contain(s) one or more macromonomeric structural units (B) of the formula (III) in which R^{x} is H, I=0 and p on molar average is a number from 1 to 150, preferably from 11 to 100 and more preferably from 12 to 50, and Z is O(CH₂)₄, and optionally additionally one or more macromonomeric structural units (B) of the formula (III) in which R^{x} is the same or different and is represented by H and/or methyl, I on molar average is a number from 1 to 6, preferably from 1 to 5 and more preferably from 2 to 5, and p on molar average is a number from 1 to 150, preferably from 11 to 100 and more preferably from 12 to 50, and Z is C═O.

In a preferred embodiment of the invention, the one or more copolymers of component Z1) of the laundry detergent compositions of the invention contain(s)
(i) one or more macromonomeric structural units (B) of the formula (III) in which R^{x} is H, I=0 and p on molar average is a number from 1 to 150, preferably from 11 to 100 and more preferably from 12 to 50, and Z is O(CH₂)₄ (referred to hereinafter as “macromonomer structural units B-1”) and
(ii) one or more macromonomeric structural units (B) of the formula (III) in which R^{x} is the same or different and is represented by H and/or methyl, I on molar average is a number from 1 to 6, preferably from 1 to 5 and more preferably from 2 to 5, and p on molar average is a number from 1 to 150, preferably from 11 to 100 and more preferably from 12 to 50, and Z is C═O (referred to hereinafter as “macromonomer structural units B-2”).

In a further preferred embodiment of the invention, the one or more copolymers of component Z1) of the laundry detergent compositions of the invention contain(s) structural units (A) and (B) only as repeat structural units, and no further repeat structural units beyond that. In this preferred embodiment of the invention, the one or more copolymers of component Z1) of the laundry detergent compositions of the invention contain(s) the one or more structural units (A) preferably in an amount of 30 to 70 mol % and more preferably in an amount of 40 to 60 mol %, and the one or more structural units (B) preferably in an amount of 70 to 30 mol % and more preferably in an amount of 60 to 40 mol %. In this preferred embodiment of the invention, further preferably, the one or more copolymers of component Z1) of the laundry detergent compositions of the invention contain(s) both one or more macromonomer structural units B-1) and one or more macromonomer structural units B-2, and the molar ratio of (macromonomer structural units B-1):(macromonomer structural units B-2) in these copolymers of component Z1) is preferably from 70:30 to 30:70, more preferably from 60:40 to 40:60 and especially preferably 50:50. In this preferred embodiment of the invention, further preferably, the one or more structural units (A) are the polymerization product of at least one monomer species selected from the group consisting of [3-(methacryloylamino)propyl]trimethylammonium chloride and [3-(acryloylamino)propyl]trimethylammonium chloride.

In a further preferred embodiment of the invention, the one or more copolymers of component Z1) of the laundry detergent compositions of the invention, in addition to the structural units (A) and (B), contain(s) one or more structural units (C) which differ from the structural units (A) and (B), where the one or more copolymers contain preferably 0.1 to 99.8 mol % of the one or more structural units (A), 0.1 to 99.8 mol % of the one or more structural units (B) and 0.1 to 99.8 mol % of the one or more structural units (C),

more preferably 12.0 to 55.0 mol % of the one or more structural units (A), 15.0 to 87.9 mol % of the one or more structural units (B) and 0.1 to 48.0 mol % of the one or more structural units (C), and

especially preferably 12.0 to 52.0 mol % of the one or more structural units (A), 20.0 to 85.0 mol % of the one or more structural units (B) and 2.0 to 45.0 mol % of the one or more structural units (C).

Preferably, the one or more structural units (C) of the one or more copolymers of component Z1) of the laundry detergent compositions of the invention are the polymerization product of at least one monomer species selected from the group consisting of noncationic acrylamides, noncationic methacrylamides and N-vinyl-substituted lactams having 5 to 7 ring atoms.

More preferably, the one or more structural units (C) of the one or more copolymers of component Z1) of the laundry detergent compositions of the invention are selected from the group consisting of the polymerization product of at least one N-vinyl-substituted lactam having 5 to 7 ring atoms and the structural units of the formulae (IV) and (V):

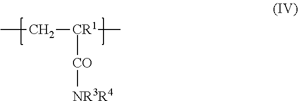

in which
R¹ is the same or different and is hydrogen and/or methyl, and
R³ and R⁴ are each the same or different and are each independently represented by hydrogen, an aliphatic hydrocarbyl radical having 1 to 20 and preferably 1 to 4 carbon atoms, a cycloaliphatic hydrocarbyl radical having 5 to 20 and preferably 5 to 8 carbon atoms, an aryl radical having 6 to 14 carbon atoms, an alkylaryl radical having 7 to 14 carbon atoms, a branched or unbranched C₁-C₅-monohydroxyalkyl group and/or polyethylene glycol (PEG),

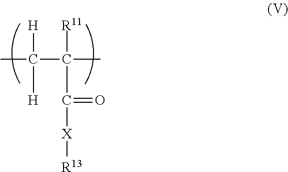

in which
R¹¹ is the same or different and is represented by H and/or methyl;
X is the same or different and is represented by NH—(CₙH₂ₙ) with n=1, 2, 3 or 4; and
R¹³ is the same or different and is represented by OH, N(CH₃)₂, SO₃H, PO₃H₂, O—PO₃H₂ and/or para-substituted C₆H₄—SO₃H.

A preferred polymerization product selected from N-vinyl-substituted lactams having 5 to 7 ring atoms is the polymerization product of N-vinylpyrrolidone.

The SO₃H, PO₃H₂, O—PO₃H₂ and para-substituted C₆H₄—SO₃H groups in the structural units of the formula (V) may also be in salt form, preferably in the form of the NH₄⁺, alkali metal or alkaline earth metal salt and more preferably of the NH₄⁺ salt or Na⁺ salt.

Among the structural units of the formula (V) in which R¹³ is N(CH₃)₂, preference is given to those structural units that are the polymerization product of at least one monomer species selected from the group consisting of [3-(methacryloylamino)propyl]dimethylamine (R¹¹=methyl; X═NH—(CₙH₂ₙ) with n=3 and R¹³═N(CH₃)₂) and [3-(acryloylamino)propyl]dimethylamine (R¹¹═H; X═NH—(CₙH₂ₙ) with n=3 and R¹³═N(CH₃)₂).

Among the structural units of the formula (V), preference is given to those that are the polymerization product of at least one monomer species selected from the group consisting of [3-(acryloylamino)propyl]dimethylamine, [3-(methacryloylamino)propyl]dimethylamine, 2-acryloylamino-2-methylpropanesulfonic acid and the salts of 2-acryloylamino-2-methylpropanesulfonic acid, and more preferably those that are the polymerization product of at least one monomer species selected from the group consisting of 2-acryloylamino-2-methylpropanesulfonic acid and the salts of 2-acryloylamino-2-methylpropanesulfonic acid.

Especially preferably, the one or more structural units (C) of the one or more copolymers of component Z1) of the laundry detergent compositions of the invention is/are selected from the structural units of the formula (IV).

Exceptionally preferably, the one or more structural units (C) of the one or more copolymers of component Z1) of the laundry detergent compositions of the invention are the polymerization product of at least one monomer species selected from the group consisting of acrylamide, methacrylamide, N-methylacrylamide, N,N-dimethylacrylamide, N-ethylacrylamide, N-cyclohexylacrylamide, N-benzylacrylamide, N-methylolacrylamide, N-isopropylacrylamide and N-tert-butylacrylamide, the one or more structural units (C) of the one or more copolymers of component Z1) of the laundry detergent compositions of the invention even more preferably being the polymerization product of at least one monomer species selected from the group consisting of N,N-dimethylacrylamide and N-isopropylacrylamide, the one or more structural units (C) of the one or more copolymers of component Z1) of the laundry detergent compositions of the invention even further preferably being the polymerization product of N-isopropylacrylamide.

In a further preferred embodiment of the invention, the one or more copolymers of component Z1) of the laundry detergent compositions of the invention contain(s) structural units (A), (B) and (C) only as repeat structural units, and no further repeat structural units beyond that. In this preferred embodiment of the invention, the one or more copolymers of component Z1) of the laundry detergent compositions of the invention contain(s) the one or more structural units (A) preferably in an amount of 15.0 to 65.0 mol % and more preferably in an amount of 20.0 to 60.0 mol %, the one or more structural units (B) preferably in an amount of 15.0 to 45.0 mol % and more preferably in an amount of 20.0 to 40.0 mol %, and the one or more structural units (C) preferably in an amount of 5.0 to 55.0 mol % and more preferably in an amount of 10.0 to 50.0 mol %.

In this preferred embodiment of the invention, further preferably, the one or more structural units (A) are the polymerization product of at least one monomer species selected from the group consisting of [3-(methacryloylamino)propyl]trimethylammonium chloride and [3-(acryloylamino)propyl]trimethylammonium chloride, the one or more structural units (B) are selected from the group consisting of the macromonomer structural units B-1 and the macromonomer structural units B-2, and the one or more structural units (C) are the polymerization product of at least one monomer species selected from the group consisting of N,N-dimethylacrylamide, N-isopropylacrylamide, 2-acryloylamino-2-methylpropanesulfonic acid and the salts of 2-acryloylamino-2-methylpropanesulfonic acid.

In the further-preferred embodiment of the invention just described, the one or more copolymers of component Z1) of the laundry detergent compositions of the invention, in a particularly preferred embodiment of the invention, contain either macromonomer structural units B-1 only or macromonomer structural units B-2 only.

In the further-preferred embodiment of the invention just described, the one or more copolymers of component Z1) of the laundry detergent compositions of the invention, in another particularly preferred embodiment of the invention, contain both macromonomer structural units B-1 and macromonomer structural units B-2. In this context, the molar ratio of (macromonomer structural units B-1):(macromonomer structural units B-2) is preferably from 1:20 to 20:1 and more preferably from 1:15 to 15:1.

In a further preferred embodiment of the invention, the one or more copolymers of component Z1) of the laundry detergent compositions of the invention, in addition to the structural units (A), (B) and (C), contain(s) one or more structural units (D) which differ from the structural units (A), (B) and (C), where the one or more copolymers contain preferably 0.1 to 99.7 mol % of the one or more structural units (A), 0.1 to 99.7 mol % of the one or more structural units (B), 0.1 to 99.7 mol % of the one or more structural units (C) and 0.1 to 99.7 mol % of the one or more structural units (D), more preferably 12.0 to 50.0 mol % of the one or more structural units (A), 15.0 to 50.0 mol % of the one or more structural units (B), 0.1 to 38.0 mol % of the one or more structural units (C) and 0.1 to 35.0 mol % of the one or more structural units (D), and especially preferably 12.0 to 40.0 mol % of the one or more structural units (A), 20.0 to 40.0 mol % of the one or more structural units (B), 2.5 to 36.0 mol % of the one or more structural units (C) and 0.5 to 30.0 mol % of the one or more structural units (D).

If the one or more copolymers of component Z1) of the laundry detergent compositions of the invention contain one or more structural units (D), in a particularly preferred embodiment of the invention, they contain one or more structural units (D) selected from the structural units of the following formula (VIII):

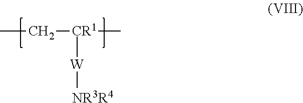

in which
W is the same or different and is represented by —CO—O—(CH₂)ₓ,
x is an integer from 1 to 6, preferably 2 or 3,
R¹ is the same or different and is hydrogen and/or methyl, and
R³ and R⁴ are each the same or different and are each independently represented by hydrogen, an aliphatic hydrocarbyl radical having 1 to 20 and preferably 1 to 4 carbon atoms, a cycloaliphatic hydrocarbyl radical having 5 to 20 and preferably 5 to 8 carbon atoms, an aryl radical having 6 to 14 carbon atoms and/or polyethylene glycol (PEG),

If the one or more copolymers of component Z1) of the laundry detergent compositions of the invention contain one or more structural units (D), these are selected, in an especially preferred embodiment of the invention, from the structural units of the formula (VIII).

Among the structural units of the formula (VIII), preference is given to those that are the polymerization product of at least one monomer species selected from the group consisting of [2-(methacryloyloxy)ethyl]dimethylamine, [2-(acryloyloxy)ethyl]dimethylamine, [2-(methacryloyloxy)ethyl]diethylamine and [2-(acryloyloxy)ethyl]diethylamine.

If the one or more copolymers of component Z1) of the laundry detergent compositions of the invention contain one or more structural units (D), in a further particularly preferred embodiment of the invention, they contain one or more structural units (D) selected from the structural units of the following formulae (IX) and/or (X):

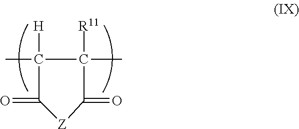

in which
R¹¹ is the same or different and is represented by H and/or methyl;
Z is the same or different and is represented by O and/or NH;

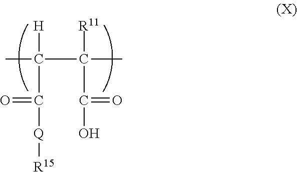

in which
R¹¹ is the same or different and is represented by H and/or methyl;
Q is the same or different and is represented by O and/or NH; and
R¹⁵ is the same or different and is represented by H, (CₙH₂ₙ)—SO₃H with n=0, 1, 2, 3 or 4; (CₙH₂ₙ)—OH with n=0, 1, 2, 3 or 4; (CₙH₂ₙ)—PO₃H₂ with n=0, 1, 2, 3 or 4; (CₙH₂ₙ)—OPO₃H₂ with n=0, 1, 2, 3 or 4; (C₆H₄)—SO₃H; (C₆H₄)—PO₃H₂; (C₆H₄)—OPO₃H₂ and/or (CₘH₂ₘ)ₑ—O-(A′O)ᵤ—R¹⁶ with m=0, 1, 2, 3 or 4, e=0, 1, 2, 3 or 4, A′=C_{x′}H_{2x′} with x′=2, 3, 4 or 5, u=an integer from 1 to 350 and R¹⁶ is the same or different and represented by an unbranched or branched C₁-C₄-alkyl group.

If the one or more copolymers of component Z1) of the laundry detergent compositions of the invention contain one or more structural units (D), these are selected, in a further especially preferred embodiment of the invention, from the structural units of the formulae (IX) and/or (X).

The structural units of the formula (X) may also be in salt form, preferably in the form of the NH₄⁺, alkali metal or alkaline earth metal salt and more preferably in the form of the NH₄⁺ salt or in the form of the Na⁺ salt.

Among the structural units of the formulae (IX) and (X), preference is given to those that are the polymerization product of at least one monomer species selected from the group consisting of maleic anhydride, maleic acid and the salts of maleic acid.

If the one or more copolymers of component Z1) of the laundry detergent compositions of the invention contain one or more structural units (D), in a further particularly preferred embodiment of the invention, they contain one or more structural units (D) selected from the structural units of the following formula (VII):

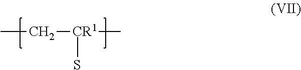

in which
S is the same or different and is represented by —COOMₖ,
R¹ is the same or different and is represented by H and/or an unbranched or branched C₁-C₄-alkyl group and is preferably represented by H or methyl; and
M is a cation selected from the group consisting of hydrogen ion, alkali metal ion and alkaline earth metal ion, with k=valency.

If the one or more copolymers of component Z1) of the laundry detergent compositions of the invention contain one or more structural units (D), these are selected, in a further especially preferred embodiment of the invention, from the structural units of the formula (VII).

Among the structural units of the formula (VII), preference is given to those that are the polymerization product of at least one monomer species selected from the group consisting of acrylic acid, sodium acrylate, potassium acrylate, methacrylic acid, sodium methacrylate and potassium methacrylate.

If the one or more copolymers of component Z1) of the laundry detergent compositions of the invention contain one or more structural units (D), in a further particularly preferred embodiment of the invention, they contain one or more structural units (D) selected from the structural units of the following formulae (Va), (Vb) and/or (Vc):

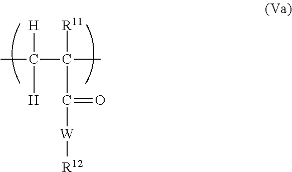

in which
R¹¹ is the same or different and is represented by H and/or methyl;
W is the same or different and is represented by O;
R¹² is the same or different and is represented by a branched or unbranched C₁-C₅-monohydroxyalkyl group;

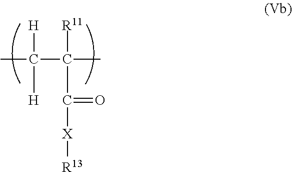

in which
R¹¹ is the same or different and is represented by H and/or methyl;
X is the same or different and is represented by O—(CₙH₂ₙ) with n=1, 2, 3 or 4;
R¹³ is the same or different and is represented by OH, SO₃H, PO₃H₂, O—PO₃H₂ and/or para-substituted C₆H₄—SO₃H;

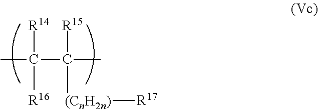

in which
R¹⁴, R¹⁵ and R¹⁶ are each the same or different and are each independently represented by H and/or an unbranched or branched C₁-C₄-alkyl group;
n is the same or different and is represented by 0, 1, 2, 3 and/or 4;
R¹⁷ is the same or different and is represented by (C₆H₅), OH, OR^{y} where R^{y} is an alkyl group having 1 to 8 and preferably 4 carbon atoms, and/or —OOCCH₃.

If the one or more copolymers of component Z1) of the laundry detergent compositions of the invention contain one or more structural units (D), these are selected, in a further especially preferred embodiment of the invention, from the structural units of the formulae (Va), (Vb) and/or (Vc).

The SO₃H, PO₃H₂, O—PO₃H₂ and para-substituted C₆H₄—SO₃H groups in the structural units of the formula (Vc) may also be in salt form, preferably in the form of the NH₄⁺, alkali metal or alkaline earth metal salt and more preferably of the NH₄⁺ salt or of the Na⁺ salt.

Among the structural units of the formula (Vc), preference is given to those that are the polymerization product of at least one monomer species selected from the group consisting of vinyl butyl ether and vinyl acetate.

In a further preferred embodiment of the invention, the one or more copolymers of component Z1) of the laundry detergent compositions of the invention contain(s) structural units (A), (B), (C) and (D) only as repeat structural units, and no further repeat structural units beyond that. In this preferred embodiment of the invention, the one or more copolymers of component Z1) of the laundry detergent compositions of the invention contain(s) the one or more structural units (A) preferably in an amount of 5.0 to 35.0 mol % and more preferably in an amount of 10.0 to 30.0 mol %, the one or more structural units (B) preferably in an amount of 5.0 to 35.0 mol % and more preferably in an amount of 10.0 to 30.0 mol %, the one or more structural units (C) preferably in an amount of 20.0 to 50.0 mol % and more preferably in an amount of 25.0 to 45.0 mol %, and the one or more structural units (D) preferably in an amount of 10.0 to 40.0 mol % and more preferably in an amount of 15.0 to 35.0 mol %.

In this preferred embodiment of the invention, further preferably, the one or more structural units (A) are the polymerization product of at least one monomer species selected from the group consisting of [3-(methacryloylamino)propyl]trimethylammonium chloride and [3-(acryloylamino)propyl]trimethylammonium chloride, the one or more structural units (B) are selected from the group consisting of the macromonomer structural units B-1 and the macromonomer structural units B-2, preferably containing both macromonomer structural units B-1 and macromonomer structural units B-2, and the one or more structural units (C) are the polymerization product of at least one monomer species selected from the group consisting of N,N-dimethylacrylamide and N-isopropylacrylamide, preferably of N-isopropylacrylamide, and the one or more structural units (D) are the polymerization product of at least one monomer species selected from the group consisting of acrylic acid, methacrylic acid, the salts of acrylic acid and the salts of methacrylic acid.

In the further-preferred embodiment of the invention just described, the one or more copolymers of component Z1) of the laundry detergent compositions of the invention preferably contain both macromonomer structural units B-1 and macromonomer structural units B-2. In this context, the molar ratio of (macromonomer structural units B-1):(macromonomer structural units B-2) is preferably from 1:20 to 20:1 and more preferably from 1:15 to 15:1.

Preferably, the structural units (A), (B) and, if present, (C) and (D) in the one or more copolymers of component Z1) of the laundry detergent compositions of the invention are in a random, blockwise, alternating or gradient distribution in the copolymer.

Preferably, the weight-average molecular weight M_{w} of the one or more copolymers of component Z1) of the laundry detergent compositions of the invention is from 10 000 to 400 000 g/mol, more preferably from 15 000 to 350 000 g/mol and especially preferably from 50 000 to 330 000 g/mol.

The weight-average molecular weight M_{w} of the copolymers of component Z1) of the laundry detergent compositions of the invention can be determined by gel permeation chromatography (GPC), preferably as follows: 10 μL of the sample are injected into a PSS Novema Max Guard column of the following dimensions: 300×8 mm with a permeability of 1×30 Å and 2×1000 Å and particle size of 10 μm. Detection is effected via the refractive index at 25° C. The eluent used is 79.7% by volume of 0.1 M NaCl+0.3% by volume of TFA (trifluoroacetic acid)+20.0% by volume of ACN (acetonitrile). Separation is effected at a flow rate of 1 mL/minute. The size is determined by comparison with the elution time of standard samples of poly(2-vinylpyridines) of defined molecular weights in the range from 1110 to 1 060 000 daltons.

The copolymers of component Z1) of the laundry detergent compositions of the invention contain repeat structural units (generally —C(Rs1)(Rs2)-C(Rs3)(Rs4)-) that are the polymerization product of appropriate monomers with polymerizable olefinic double bonds (generally C(Rs1)(Rs2)=C(Rs3)(Rs4)). The Rs1, Rs2, Rs3 and Rs4 radicals are not defined here in detail, but merely for the sake of completeness are specified as radicals bonded to the corresponding carbon atoms “C”. The structural units (A) and (B) that are present in the copolymers of component Z1) and the structural units (C) and (D) that are optionally additionally present in the copolymers of component Z1) are, for example, repeat structural units of this kind. Structural units that originate, for example, from free-radical initiators or from any chain-transfer agents used in the copolymerization are not repeat structural units. Accordingly, repeat structural units are not understood to mean terminal groups, for example. The amounts in mol % that are stated for the structural units (A), (B), (C) and (D) are based on the total amount of the repeat structural units present in the respective copolymers of component Z1).

The copolymers of component Z1) of the laundry detergent compositions of the invention can be prepared by methods familiar to those skilled in the art. More preferably, the copolymers of component Z1) can be prepared by free-radical solution polymerization. Standard solvents may preferably be polar solvents such as alcohols or water, and alcohol-water mixtures. The polymerization is initiated by free-radical sources, for example inorganic persulfates, organic azo compounds, peroxides, hydroperoxides, inorganic redox systems, or UV light. In addition, it is possible to use chain-transfer agents that form less reactive free radicals, in order to control the molecular weight of the copolymers. Chain-transfer agents of this kind are, for example, phenols, thiols, for example sodium 2-mercaptoethanesulfonate, or sodium hypophosphite. In an illustrative procedure, the monomers for preparation of the copolymers of component Z1) and, if appropriate, a chain-transfer agent are dissolved in the solvent, oxygen is driven out, then the temperature is increased, and the free-radical initiator is metered in. The copolymerization is then conducted at the desired temperature for the desired period of time. The reaction mixture is then optionally cooled and the copolymer formed is either processed further in solution or worked up; for example, the solution containing the copolymer can be concentrated by partly evaporating off the solvent, optionally under reduced pressure, or the solvent can be removed completely by evaporating it off or else the copolymer can be isolated in some other way, for example by freeze-drying or precipitation.

Preferably, the one or more surfactants of component Z2) of the laundry detergent compositions of the invention are selected from the group consisting of anionic, nonionic, amphoteric and cationic surfactants.

More preferably, the one or more surfactants of component Z2) of the laundry detergent compositions of the invention are selected from the group consisting of fatty alcohol polyglycol ethers, alkyl polyglycosides, alkylbenzenesulfonates, alkanesulfonates, alkyl ether sulfates, alkyl sulfates, glucamides, amine oxides, betaines and quaternary ammonium compounds.

Examples of anionic surfactants are alkylbenzenesulfonates, alkyl sulfates, alkyl ether sulfates, alkanesulfonates, alkyl ether carboxylic acids, sulfosuccinates, isethionates, taurates, glycinates and/or acylglutamates. The alkyl chains of the surfactants mentioned may be of synthetic or natural origin and consist preferably of 8 to 30, more preferably 8 to 18 and especially preferably 12 to 14 carbon atoms in a linear or branched arrangement.

Anionic surfactants that are used in accordance with the invention are preferably aliphatic sulfates such as fatty alcohol sulfates, fatty alcohol ether sulfates, dialkyl ether sulfates, monoglyceride sulfates, and aliphatic sulfonates such as alkanesulfonates, olefinsulfonates, ether sulfonates, n-alkyl ether sulfonates, ester sulfonates and lignosulfonates. Likewise usable in the context of the present invention are alkylbenzenesulfonates, fatty acid cyanamides, sulfosuccinates (sulfosuccinic esters), sulfosuccinamates, sulfosuccinamides, fatty acid isethionates, acylaminoalkanesulfonates (fatty acid taurides), fatty acid sarcosinates, ether carboxylic acids and alkyl (ether) phosphates, and also [alpha]-sulfo fatty acid salts, acylglutamates, monoglyceride disulfates and alkyl ethers of glycerol disulfate.

Among these, preference is given to the fatty alcohol sulfates and/or fatty alcohol ether sulfates, especially the fatty alcohol sulfates. Fatty alcohol sulfates are products of sulfation reactions on corresponding alcohols, while fatty alcohol ether sulfates are products of sulfation reactions on alkoxylated alcohols. The person skilled in the art generally understands alkoxylated alcohols to mean the reaction products of alkylene oxide, preferably ethylene oxide, with alcohols, in the context of the present invention preferably with longer-chain alcohols. In general, n moles of ethylene oxide and one mole of alcohol, depending on the reaction conditions, give rise to a complex mixture of addition products of different degrees of ethoxylation. A further embodiment of the alkoxylation involves the use of mixtures of alkylene oxides, preferably of the mixture of ethylene oxide and propylene oxide. Preferred fatty alcohol ether sulfates are the sulfates of fatty alcohols having low levels of ethoxylation with 1 to 4 ethylene oxide units (EO), especially 1 to 2 EO, for example 1.3 EO.

Particular preference is given to alkylbenzenesulfonate, alkanesulfonate, alkyl ether sulfate or alkyl sulfate.

The anionic surfactants are typically used in the form of salts, but also in acid form. The salts are preferably alkali metal salts, alkaline earth metal salts, ammonium salts and mono-, di- or trialkanolammonium salts, for example mono-, di- or triethanolammonium salts, especially lithium, sodium, potassium or ammonium salts, more preferably sodium or potassium salts, especially preferably sodium salts.

Further surfactants may be nonionic, amphoteric and/or cationic surfactants, for example betaines, amidobetaines, amine oxides, amidoamine oxides, fatty alcohol polyglycol ethers, alkyl polyglycosides or else quaternary ammonium compounds.

Further nonionic surfactants may, for example, be alkoxylates, such as polyglycol ethers, fatty alcohol polyglycol ethers (fatty alcohol alkoxylates), alkyl phenol polyglycol ethers, end group-capped polyglycol ethers, mixed ethers and hydroxy mixed ethers, and fatty acid polyglycol esters. Likewise usable are ethylene oxide-propylene oxide block polymers and fatty acid alkanolamides and fatty acid polyglycol ethers. A further important class of nonionic surfactants that can be used in accordance with the invention is that of the polyol surfactants and here particularly the glycosurfactants, such as alkyl polyglycosides, especially alkyl polyglucosides.

Suitable fatty alcohol polyglycol ethers are ethylene oxide (EO)- and/or propylene oxide (PO)-alkoxylated, unbranched or branched, saturated or unsaturated C₈-C₂₂ alcohols having an alkoxylation level of up to 30, preferably ethoxylated C₁₀-C₁₈ fatty alcohols having an ethoxylation level of less than 30, more preferably 1 to 20, especially preferably 1 to 12 and exceptionally preferably 1 to 8, for example C₁₂-C₁₄ fatty alcohol ethoxylates with 8 EO.

Alkyl polyglycosides are surfactants that can be obtained by the reaction of sugars and alcohols by the relevant methods of preparative organic chemistry, which results in a mixture of monoalkylated, oligomeric or polymeric sugars according to the manner of preparation. Preferred alkyl polyglycosides are the alkyl polyglucosides, where the alcohol is more preferably a long-chain fatty alcohol or a mixture of long-chain fatty alcohols having branched or unbranched C₈- to C₈a-alkyl chains and the oligomerization level (DP) of the sugars is between 1 and 10, preferably 1 to 6, more preferably 1.1 to 3 and especially preferably 1.1 to 1.7, for example C₈-C₁₀-alkyl-1.5-glucoside (DP of 1.5).

The amphosurfactants (zwitterionic surfactants) that are usable in accordance with the invention include betaines, amine oxides, alkylamidoalkylamines, alkyl-substituted amino acids, acylated amino acids and biosurfactants.

Suitable betaines are the alkyl betaines, the alkylamidobetaines, the imidazolinium betaines, the sulfobetaines (INCI Sultaines) and the amidosulfobetaines, and also the phosphobetaines. Examples of suitable betaines and sulfobetaines are the following compounds named according to INCI: Almondamidopropyl Betaine, Apricotam idopropylbetaine, Avocadam idopropylbetaine, Babassuam idopropylbetaine, Behenamidopropylbetaine, Behenylbetaine, Betaine, Canolamidopropylbetaine, Capryl/Capramidopropylbetaine, Carnitine, Cetylbetaine, Cocamidoethylbetaine, Cocamidopropylbetaine, Cocam idopropylhydroxysultaine, Cocobetaine, Cocohydroxysultaine, Coco/Oleamidopropylbetaine, Coco-Sultaine, Decylbetaine, Dihydroxyethyloleylglycinate, Dihydroxyethyl Soy Glycinate, Dihydroxyethylstearylglycinate, Dihydroxyethyl Tallow Glycinate, Dimethicone Propyl PG-Betaine, Erucamidopropylhydroxysultaine, Hydrogenated Tallow Betaine, Isostearamidopropylbetaine, Lauramidopropylbetaine, Laurylbetaine, Laurylhydroxysultaine, Laurylsultaine, Milkamidopropylbetaine, Minkamidopropylbetaine, Myristamidopropylbetaine, Myristylbetaine, Oleamidopropylbetaine, Oleamidopropylhydroxysultaine, Oleylbetaine, Olivamidopropylbetaine, Palmam idopropylbetaine, Palmitam idopropylbetaine, Palmitoyl Carnitine, Palm Kernelamidopropyl Betaine, Polytetrafluoroethylene Acetoxypropyl Betaine, Ricinoleamidopropylbetaine, Sesamidopropylbetaine, Soyamidopropylbetaine, Stearamidopropylbetaine, Stearylbetaine, Tallowamidopropylbetaine, Tallowamidopropylhydroxysultaine, Tallowbetaine, Tallowdihydroxyethylbetaine, Undecylenamidopropylbetaine and Wheat Germamidopropyl Betaine.

The amine oxides suitable in accordance with the invention include alkylamine oxides, especially alkyldimethylamine oxides, alkylamidoamine oxides and alkoxyalkylamine oxides.

Examples of suitable amine oxides are the following compounds named according to INCI: Almondamidopropylamine Oxide, Babassuamidopropylamine Oxide, Behenamine Oxide, Cocamidopropyl Amine Oxide, Cocamidopropylamine Oxide, Cocamine Oxide, Coco-Morpholine Oxide, Decylamine Oxide, Decyltetradecylamine Oxide, Diaminopyrimidine Oxide, Dihydroxyethyl C₈-C₁₀ Alkoxypropylamine Oxide, Dihydroxyethyl C₉-C₁₁ Alkoxypropylamine Oxide, Dihydroxyethyl C₁₂-C₁₅ Alkoxypropylamine Oxide, Dihydroxyethyl Cocamine Oxide, Dihydroxyethyl Lauramine Oxide, Dihydroxyethyl Stearamine Oxide, Dihydroxyethyl Tallowamine Oxide, Hydrogenated Palm Kernel Amine Oxide, Hydrogenated Tallowamine Oxide, Hydroxyethyl Hydroxypropyl C₁₂-C₁₅ Alkoxypropylamine Oxide, Isostearamidopropylamine Oxide, Isostearamidopropyl Morpholine Oxide, Lauramidopropylamine Oxide, Lauramine Oxide, Methyl Morpholine Oxide, Milkamidopropyl Amine Oxide, Minkamidopropylamine Oxide, Myristamidopropylamine Oxide, Myristamine Oxide, Myristyl/Cetyl Amine Oxide, Oleamidopropylamine Oxide, Oleamine Oxide, Olivamidopropylamine Oxide, Palmitamidopropylamine Oxide, Palmitamine Oxide, PEG-3 Lauramine Oxide, Potassium Dihydroxyethyl Cocamine Oxide Phosphate, Potassium Trisphosphonomethylamine Oxide, Sesamidopropylamine Oxide, Soyamidopropylamine Oxide, Stearamidopropylamine Oxide, Stearamine Oxide, Tallowamidopropylamine Oxide, Tallowamine Oxide, Undecylenamidopropylamine Oxide and Wheat Germamidopropylamine Oxide.

Illustrative alkylamidoalkylamines are the following compounds named according to INCI: Cocoamphodipropionic Acid, Cocobetainamido Amphopropionate, DEA-Cocoamphodipropionate, Disodium Caproamphodiacetate, Disodium Caproamphodipropionate, Disodium Capryloamphodiacetate, Disodium Capryloamphodipropionate, Disodium Cocoamphocarboxyethylhydroxypropylsulfonate, Disodium Cocoamphodiacetate, Disodium Cocoamphodipropionate, Disodium Isostearoamphodiacetate, Disodium Isostearoamphodipropionate, Disodium Laureth-5 Carboxyamphodiacetate, Disodium Lauroamphodiacetate, Disodium Lauroamphodipropionate, Disodium Oleoamphodipropionate, Disodium PPG-2-Isodeceth-7 Carboxyamphodiacetate, Disodium Stearoamphodiacetate, Disodium Tallowamphodiacetate, Disodium Wheatgermamphodiacetate, Lauroamphodipropionic Acid, Quaternium-85, Sodium Caproamphoacetate, Sodium Caproamphohydroxypropylsulfonate, Sodium Caproamphopropionate, Sodium Capryloamphoacetate, Sodium Capryloamphohydroxypropylsulfonate, Sodium Capryloamphopropionate, Sodium Cocoamphoacetate, Sodium Cocoamphohydroxypropylsulfonate, Sodium Cocoamphopropionate, Sodium Cornamphopropionate, Sodium Isostearoamphoacetate, Sodium Isostearoamphopropionate, Sodium Lauroamphoacetate, Sodium Lauroamphohydroxypropylsulfonate, Sodium Lauroampho PG-Acetate Phosphate, Sodium Lauroamphopropionate, Sodium Myristoamphoacetate, Sodium Oleoamphoacetate, Sodium Oleoamphohydroxypropylsulfonate, Sodium Oleoamphopropionate, Sodium Ricinoleoamphoacetate, Sodium Stearoamphoacetate, Sodium Stearoamphohydroxypropylsulfonate, Sodium Stearoamphopropionate, Sodium Tallamphopropionate, Sodium Tallowamphoacetate, Sodium Undecylenoamphoacetate, Sodium Undecylenoamphopropionate, Sodium Wheat Germamphoacetate and Trisodium Lauroampho PG-Acetate Chloride Phosphate.

Illustrative alkyl-substituted amino acids are the following compounds named according to INCI: Aminopropyl Laurylglutamine, Cocaminobutyric Acid, Cocaminopropionic Acid, DEA-Lauraminopropionate, Disodium Cocaminopropyl Iminodiacetate, Disodium Dicarboxyethyl Cocopropylenediamine, Disodium Lauriminodipropionate, Disodium Steariminodipropionate, Disodium Tallowiminodipropionate, Lauraminopropionic Acid, Lauryl Aminopropylglycine, Lauryl Diethylenediaminoglycine, Myristaminopropionic Acid, Sodium C₁₂-C₁₅ Alkoxypropyl Iminodipropionate, Sodium Cocaminopropionate, Sodium Lauraminopropionate, Sodium Lauriminodipropionate, Sodium Lauroyl Methylaminopropionate, TEA-Lauraminopropionate and TEA-Myristaminopropionate.

Preferably, the laundry detergent compositions of the invention comprise, in addition to the one or more copolymers of component Z1) and the one or more surfactants of component Z2), one or more further substances selected from components Z3), Z4), Z5), Z6) and/or Z7):
Z3) one or more complexing agents as component Z3),
Z4) one or more solvents other than water as component Z4),
Z5) one or more further additives, preferably selected from the group consisting of viscosity regulators, enzymes, bleaches, bleach activators, bleach catalysts, graying inhibitors, dye transfer inhibitors, dye fixatives, optical brighteners, preservatives, fragrances, dyes and buffer substances (but optionally also further additives beyond that, as described further down for example) as component Z5),
Z6) water as component Z6),
Z7) one or more builders as component Z7).

The complexing agents (INCI Chelating Agents) of component Z3), also called sequestrants, are ingredients able to complex and inactivate metal ions, in order to prevent their adverse effects on the stability or appearance of the compositions, for example cloudiness. It is firstly important to complex the calcium and magnesium ions of water hardness that are incompatible with numerous ingredients. The complexation of the ions of heavy metals such as iron or copper secondly delays the oxidative breakdown of the finished compositions. Moreover, the complexing agents promote detergent action.

Suitable examples are the following complexing agents named according to INCI: Aminotrimethylene, Phosphonic Acid, Beta-Alanine Diacetic Acid, Calcium Disodium EDTA, Citric Acid, Cyclodextrin, Cyclohexanediamine Tetraacetic Acid, Diammonium Citrate, Diammonium EDTA, Diethylenetriamine Pentamethylene Phosphonic Acid, Dipotassium EDTA, Disodium Azacycloheptane Diphosphonate, Disodium EDTA, Disodium Pyrophosphate, EDTA, Etidronic Acid, Galactaric Acid, Gluconic Acid, Glucuronic Acid, HEDTA, Hydroxypropyl Cyclodextrin, Methyl Cyclodextrin, Pentapotassium Triphosphate, Pentasodium Am inotrimethylene Phosphonate, Pentasodium Ethylenediamine Tetramethylene Phosphonate, Pentasodium Pentetate, Pentasodium Triphosphate, Pentetic Acid, Phytic Acid, Potassium Citrate, Potassium EDTMP, Potassium Gluconate, Potassium Polyphosphate, Potassium Trisphosphonomethylamine Oxide, Ribonic Acid, Sodium Chitosan Methylene Phosphonate, Sodium Citrate, Sodium Diethylenetriamine Pentamethylene Phosphonate, Sodium Dihydroxyethylglycinate, Sodium EDTMP, Sodium Gluceptate, Sodium Gluconate, Sodium Glycereth-1 Polyphosphate, Sodium Hexametaphosphate, Sodium Metaphosphate, Sodium Metasilicate, Sodium Phytate, Sodium Polydimethylglycinophenolsulfonate, Sodium Trimetaphosphate, TEA-EDTA, TEA-Polyphosphate, Tetrahydroxyethyl Ethylenediamine, Tetrahydroxypropyl Ethylenediamine, Tetrapotassium Etidronate, Tetrapotassium Pyrophosphate, Tetrasodium EDTA, Tetrasodium Etidronate, Tetrasodium Pyrophosphate, Tripotassium EDTA, Trisodium Dicarboxymethyl Alaninate, Trisodium EDTA, Trisodium HEDTA, Trisodium NTA and Trisodium Phosphate.

Preferred complexing agents include organic phosphonates, alkanehydroxyphosphonates and carboxylates, which are available under the DEQUEST brand name from Thermphos. A particularly preferred complexing agent is HEDP (1-hydroxyethylidene-1,1-diphosphonic acid), which is sold, for example, as Dequest 2010. Dequest® 2066 (diethylenetriaminepenta(methylenephosphonic acid) or heptasodium-DTPMP) is likewise suitable but less preferred since it gives worse cleaning outcomes.

The proportion of component Z3), if it is not 0%, is preferably from 0.001% to 10% by weight, more preferably from 0.005% to 7% by weight and especially preferably from 0.01% to 5% by weight, based in each case on the total weight of the laundry detergent composition of the invention.

If the laundry detergent composition of the invention is liquid, it may also comprise one or more nonaqueous solvents or hydrotropes as component Z4). In the context of the present invention, a hydrotrope is a solvent which is neither water nor a conventional surfactant and promotes the solubilization of the surfactants and other components, especially polymer and complexing agent, in the liquid, in order to make it isotropic. Suitable hydrotropes preferably include: monopropylene glycol (MPG), glycerol, sodium cumenesulfonate, ethanol, other glycols, e.g. dipropylene glycol, diethers and urea. Preferred hydrotropes are MPG and glycerol.

The proportion of component Z4), if it is not 0%, is preferably from 0.001% to 50% by weight, more preferably from 0.01% to 30% by weight and especially preferably from 0.1% to 20% by weight, based in each case on the total weight of the laundry detergent composition of the invention.

As well as the ingredients already listed as Z1), Z2), Z3), and Z4), the laundry detergent compositions of the invention may comprise one or more optional ingredients Z5), for example conventional ingredients which are typically used in laundry detergent compositions, especially textile laundry detergent compositions. Examples of optional ingredients include viscosity regulators, bleaches, bleach-active compounds, bleach activators, bleach catalysts, photochemical bleaches, dye transfer inhibitors, dye fixatives, graying inhibitors, dispersants, fabric softeners, antistats, optical brighteners, enzymes, enzyme stabilizers, foam regulators, defoamers, deodorants, preservatives, disinfectants, fiber glidants, anticrease agents, buffer substances, fragrances, processing auxiliaries, colorants, dyes, pigments, corrosion inhibitors, fillers, stabilizers and other conventional ingredients of laundry detergent compositions.

As well as the copolymers described as component Z1), the laundry detergent compositions of the invention may comprise further polymers to promote the washing performance. Examples of these are polyalkoxylated polyethyleneimines, e.g. polyethoxylated polyethyleneimines (EPEI), and conventional polyester-based soil release polymers. Polyethyleneimines are substances formed from ethyleneimine units —CH₂CH₂NH—, where the hydrogen on the nitrogen in the case of branching is replaced by a further chain of ethyleneimine units. These polyethyleneimines can be prepared, for example, by polymerization of ethyleneimine in the presence of a catalyst such as carbon dioxide, sodium bisulfite, sulfuric acid, hydrogen peroxide, hydrochloric acid, acetic acid and the like. Specific methods of preparing these main polyamine chains can be found in U.S. Pat. Nos. 2,182,306, 3,033,746, 2,208,095, 2,806,839 and 2,553,696.

The proportion of the polyalkoxylated polyethyleneimines, if it is not 0%, is preferably from 0.05% to 10% by weight and more preferably from 0.1% to 6% by weight, based in each case on the total weight of the laundry detergent composition of the invention.

Polyester-based soil release polymers generally comprise polymers of aromatic dicarboxylic acids and alkylene glycols (including polymers that additionally contain polyalkylene glycols). The polymeric soil release agents usable here especially include those soil release agents having (a) one or more nonionic hydrophilic components consisting essentially of (i) polyoxyethylene segments having a polymerization level of at least 2 or (ii) oxypropylene or polyoxypropylene segments having a polymerization level of 2 to 10, where the hydrophilic segment does not include any oxypropylene units, except when they are bonded via ether bonds to adjacent moieties at each end, or (iii) a mixture of oxyalkylene units comprising oxyethylene units and 1 to about 30 oxypropylene units, where the mixture contains a sufficiently great amount of oxyethylene units for the hydrophilic component to be hydrophilic enough to increase the hydrophilicity of conventional synthetic polyester fiber surfaces on deposition of the soil release agent on such a surface, where the hydrophilic segments contain preferably at least 25% oxyethylene units and more preferably, especially for those components having about 20 to 30 oxypropylene units, at least about 50% oxyethylene units; or (b) one or more hydrophobic components comprising: (i) C₃-oxyalkylene terephthalate segments where, when the hydrophobic components also include oxyethylene terephthalate, the ratio of oxyethylene terephthalate to C₃-oxyalkylene terephthalate units is about 2:1 or less, (ii) C₄-C₆-alkylene or oxy-C₄-C₆-alkylene segments or mixtures thereof, (iii) poly(vinyl ester) segments, preferably polyvinyl acetate, with a polymerization level of at least 2 or (iv) C₁-C₄-alkyl ether or C₄-hydroxyalkyl ether substituents or mixtures thereof, where the substituents are in the form of C₁-C₄-alkyl ether or C₄-hydroxyalkyl ether cellulose derivatives or mixtures thereof and cellulose derivatives of this kind are amphiphilic, where they have a sufficient content of C₁-C₄-alkyl ether and/or C₄-hydroxyalkyl ether units to be deposited on conventional synthetic polyester fiber surfaces and, after adhering on a conventional synthetic fiber surface of this kind, retain a sufficient content of hydroxyl groups to increase the hydrophilicity of the fiber surface, or a combination of (a) and (b).

Typically, the polyoxyethylene segments of (a) (i) have a polymerization level of about 1 to about 200, although it is also possible to use higher levels, preferably of 3 to about 150 and more preferably of 6 to about 100.

A preferred polymeric soil release agent is a polyester having repeat units formed from alkylene terephthalate units, containing 10%-30% by weight of alkylene terephthalate units together with 90%-70% by weight of polyoxyethylene terephthalate units which derive from a polyoxyethylene glycol having a mean molecular weight of 300-8000.

Examples of this polymer are the commercially available substances TexCare® SRN170 and TexCare® SRN260 from Clariant. See also U.S. Pat. No. 4,702,857.

The proportion of the polyester-based soil release polymers, if it is not 0%, is preferably from 0.05% to 5% by weight and more preferably from 0.1% to 3% by weight, based in each case on the total weight of the laundry detergent composition of the invention.

As well as the polyester-based soil release polymers and polyalkoxylated polyethyleneimines described, the laundry detergent compositions of the invention may comprise other polymer materials, for example dye transfer-inhibiting polymers or graying-inhibiting polymers. Especially in the absence of polyalkoxylated polyethyleneimines, the liquid laundry detergent compositions of the invention may comprise a polymer of polyethylene glycol and vinyl acetate, for example the lightly grafted copolymers according to WO 2007/138054. Such amphiphilic graft polymers based on water-soluble polyalkylene oxides as graft base and side chains formed by polymerization of a vinyl ester component are capable of enabling a reduction in the surfactant contents with retention of high levels of removal of oily stains.

In the case of liquid laundry detergent compositions of the invention, preference is also given to using a buffer substance as well. As well as agents that are optionally used for production of anionic surfactants, for example from LAS or fatty acids, the presence of buffer substances for regulation of pH is preferred. Useful buffer substances include one or more ethanolamines, e.g. monoethanolamine (MEA) or triethanolamine (TEA). Other suitable amino alcohol buffer substances may be selected from the group consisting of compounds having a molecular weight of more than 61 g/mol, which includes MEA. The following are also suitable in addition to the substances already mentioned: monoisopropanolamine, diisopropanolamine, triisopropanolamine, monoaminohexanol, 2-[(2-methoxyethyl)methylamino]ethanol, propanolamine, N-methylethanolamine, diethanolamine, monobutanolamine, isobutanolamine, monopentanolamine, 1-amino-3-(2-methoxyethoxy)-2-propanol, 2-methyl-4-(methylamino)-2-butanol and mixtures thereof. Possible alternatives to aminoethanol buffers are alkali metal hydroxides such as sodium hydroxide or potassium hydroxide.

The proportion of the buffer substances, if it is not 0%, is preferably from 0.01% to 10% by weight and more preferably from 0.1% to 8% by weight, based in each case on the total weight of the laundry detergent composition of the invention.

The laundry detergent compositions of the invention may comprise one or more enzymes. Preferably, the one or more enzymes are selected from the group consisting of protease, mannanase, pectate lyase, cutinase, esterase, lipase, amylase and cellulase. Less preferred additional enzymes may be selected from peroxidase and oxidase. The enzymes are preferably present together with appropriate enzyme stabilizers.

The proportion of the enzymes, if it is not 0%, is preferably from 0.01% to 8% by weight and more preferably from 0.1% to 5% by weight, based in each case on the total weight of the laundry detergent composition of the invention.

It may be advantageous to also use optical brighteners and/or bleach catalyst as further high-efficiency performance additives in the laundry detergent compositions of the invention. It is also desirable to use perfume and colorant as well. The laundry detergent compositions of the invention may additionally comprise foam-boosting agents, polyelectrolytes, antishrink agents, anticrease agents, antioxidants, sunscreens, anticorrosives, antistats and ironing aids. Liquid laundry detergent compositions of the invention may also comprise viscosity modifiers, pearlescent agents and/or opacifiers or other substances that cause visual effects.

As well as components Z1), Z2), Z3), Z4) and Z5), it is also possible to use water as component Z6) in the laundry detergent compositions of the invention. If the laundry detergent composition of the invention is liquid, the amount of water in the liquid laundry detergent composition of the invention may be from 1% to 95% by weight, based on the total weight of the liquid laundry detergent composition of the invention. Compositions having a very low water content are the most suitable for water-soluble portion pouches and capsules. In the case of pulverulent laundry detergent compositions of the invention, the amount of water is preferably less than 10% by weight, based on the total weight of the pulverulent laundry detergent composition of the invention.

The laundry detergent compositions of the invention optionally also comprise builders as component Z7). Builders include inorganic and/or organic builders, in order to lower the hardness level of the water. They may be present in the laundry detergent compositions with proportions by weight of about 5% to about 80%. Inorganic complexing agents include, for example, alkali metal, ammonium and alkanolammonium salts of polyphosphates, for instance tripolyphosphates, pyrophosphates and glass-like polymeric metaphosphates, phosphonates, silicates, carbonates including bicarbonates and sesquicarbonates, sulfates and aluminosilicates.

Examples of silicate builders are the alkali metal silicates, especially those with an SiO₂:Na₂O ratio between 1.6:1 and 3.2:1, and sheet silicates, for example sodium sheet silicates, as described in U.S. Pat. No. 4,664,839. Aluminosilicate builders are particularly preferred for the present invention. These are especially zeolites having the formula Na_{z}[(AlO₂)_{z}(SiO₂)_{y}].xH₂O in which z and y are integers of at least 6, the ratio of z to y is between 1.0 and about 0.5, and x is an integer from about 15 to about 264. Suitable aluminosilicate-based ion exchangers are commercially available. These aluminosilicates may be of crystalline or amorphous structure, and may be naturally occurring or else synthetically produced. Processes for the production of aluminosilicate-based ion exchangers are described in U.S. Pat. Nos. 3,985,669 and 4,605,509. Preferred ion exchangers based on synthetic crystalline aluminosilicates are available under the zeolite A, zeolite P(B) (including those disclosed in EP-A-0 384 070) and zeolite X name. Preference is given to aluminosilicates having a particle diameter between 0.1 and 10 μm.

Suitable organic builders include polycarboxyl compounds, for example ether polycarboxylates and oxydisuccinates, as described, for example, in U.S. Pat. Nos. 3,128,287 and 3,635,830. Reference may likewise be made to “TMS/TDS” builders from U.S. Pat. No. 4,663,071.

Other suitable builders include the ether hydroxypolycarboxylates, copolymers of maleic anhydride with ethylene or vinyl methyl ether, 1,3,5-trihydroxybenzene-2,4,6-trisulfonic acid and carboxymethyloxysuccinic acid, the alkali metal, ammonium and substituted ammonium salts of polyacetic acids, for example ethylenediaminetetraacetic acid and nitrilotriacetic acid, and polycarboxylic acids such as mellitic acid, succinic acid, oxydisuccinic acid, polymaleic acid, benzene-1,3,5-tricarboxylic acid, carboxymethyloxysuccinic acid, and the soluble salts thereof.

Citrate-based builders, e.g. citric acid and the soluble salts thereof, especially the sodium salt, are preferred polycarboxylic acid builders which can also be used in granulated formulations, especially together with zeolites and/or sheet silicates.

Further suitable builders are the 3,3-dicarboxy-4-oxa-1,6-hexanedioates and the related compounds disclosed in U.S. Pat. No. 4,566,984. When phosphorus-based builders can be used, and especially when soap bars for washing by hand are to be formulated, it is possible to use various alkali metal phosphates, for instance sodium tripolyphosphate, sodium pyrophosphate and sodium orthophosphate. It is likewise possible to use phosphonate builders such as ethane-1-hydroxy-1,1-diphosphonate and other known phosphonates as disclosed, for example, in U.S. Pat. Nos. 3,159,581, 3,213,030, 3,422,021, 3,400,148 and 3,422,137.

The proportion of component Z7), if it is not 0%, is preferably from 0.1% to 95% by weight, more preferably from 0.5% to 90% by weight and especially preferably from 0.5% to 80% by weight, based in each case on the total weight of the laundry detergent composition of the invention.

In a preferred embodiment of the invention, the laundry detergent compositions of the invention are in liquid form with a pH of 6 to 14, preferably from 6 to 12 and more preferably from 7 to 12.

Preferably, the laundry detergent compositions of the invention comprise the one or more copolymers of component Z1) in an amount of 0.0005% to 10.0% by weight, more preferably in an amount of 0.001% to 5.0% by weight and especially preferably in an amount of 0.1% to 2.0% by weight, based in each case on the total weight of the laundry detergent composition of the invention.

Preferably, the laundry detergent compositions of the invention comprise the one or more surfactants of component Z2) in an amount of 0.1% to 60.0% by weight, preferably in an amount of 0.5% to 50% by weight, more preferably in an amount of 1% to 45% by weight and especially preferably in an amount of 2% to 40% by weight, based in each case on the total weight of the laundry detergent composition of the invention.

More preferably, the laundry detergent compositions of the invention contain from 0.0005% to 10.0% by weight of component Z1) and from 0.1% to 60.0% by weight of component Z2), based in each case on the total weight of the laundry detergent composition of the invention.

The laundry detergent compositions of the invention or the one or more copolymers of component Z1) are advantageously suitable for cleaning of textiles and preferably for cleaning of cotton-containing textiles.

The invention therefore further provides for the use of the laundry detergent compositions of the invention or of the one or more copolymers of component Z1) of the laundry detergent compositions of the invention for cleaning of textiles and preferably for cleaning of cotton-containing textiles.

The laundry detergent compositions of the invention or the one or more copolymers of component Z1) of the laundry detergent compositions of the invention are additionally advantageously suitable for reducing the resoiling of the textiles and preferably the resoiling of cotton-containing textiles on which the laundry detergent compositions of the invention or the one or more copolymers of component Z1) of the laundry detergent compositions of the invention have been employed.

The invention therefore further provides for the use of the laundry detergent compositions of the invention or of one or more copolymers of component Z1) of the laundry detergent compositions of the invention, preferably in a laundry detergent composition of the invention, for reducing the resoiling of the textiles and preferably the resoiling of cotton-containing textiles on which the laundry detergent compositions of the invention or the one or more copolymers of component Z1) of the laundry detergent compositions of the invention have been employed.

In a preferred embodiment of the invention, the laundry detergent compositions of the invention comprise:
(a) 0.0005% to 10.0% by weight of component Z1),
(b) 0.1% to 60.0% by weight of component Z2),
(c) 0.0% to 10.0% by weight of component Z3),
(d) 0.0% to 50.0% by weight of component Z4),
(e) 0.0% to 10.0% by weight of component Z5),
(f) 0.0% to 95.0% by weight of component Z6), and
(g) 0.0% to 95.0% by weight of component Z7),

based in each case on the total weight of the laundry detergent composition of the invention.

The invention is elucidated in detail by examples hereinafter, without restricting it thereto. Unless explicitly stated otherwise in the examples, percentages in the examples should be understood as percent by weight (% by weight).

### EXAMPLES

The following abbreviations are used:

| | |
|---|---|
| AAPTAC | [3-(acryloylamino)propyl]trimethylammonium chloride |
| | (75% by weight active in aqueous solution) |
| AMPS | 2-acryloylamino-2-methylpropanesulfonic acid |
| | (100% active) |
| DMAA | N,N-dimethylacrylamide (100% active) |
| MAPTAC | [3-(methacryloylamino)propyl]trimethylammonium |
| | chloride (50% by weight active in aqueous solution) |
| MESNA | sodium 2-mercaptoethanesulfonate (100% active) |
| NIPAM | N-isopropylacrylamide (100% active) |
| PEG MA | polyethylene glycol-co-polypropylene glycol |
| 1000 | methacrylate 1000 g/mol, |
| | 4-5 propylene glycol units (70% by weight active in |
| | aqueous solution) |
| VA-44 | 2,2′-azobis[2-(2-imidazolin-2-yl)propane]dihydrochloride |
| | (100% active) |
| V-PEG 1100 | polyethylene glycol vinyloxybutyl ether 1100 g/mol |
| | (100% active) |

Preparation of the Copolymers

General Method for Preparation of the Copolymers

In a multineck flask equipped with a precision glass stirrer, reflux condenser and N₂ connection, under nitrogen (5 liters/hour), for the examples cited in table 1 for preparation of copolymers of component Z1), the stated amounts of chemicals (excluding the initiator) are dissolved in the stated amount of distilled water. It should be noted that some of the substances used for preparation of the copolymers of component Z1)) are used in aqueous form (see the details given for the substances used for the preparation of the copolymers of component Z1)). The distilled water specified in table 1 is added in addition to the water introduced via these substances. In the case of acidic monomers, these are pre-neutralized with base, for example alkali metal carbonate, e.g. potassium carbonate. Subsequently, the aqueous solution is purged with nitrogen for 30 minutes and heated to 60° C. In the next step, the amount of initiator specified in table 1 (VA-44) is dissolved in 10 g of distilled water and metered in over a period of 90 minutes. After the metered addition has ended, stirring is continued at an internal temperature of 60° C. for a further hour. The conversion of the reaction is checked by a subsequent analysis of the solids, and any unconverted monomers, if necessary, are reacted via a small addition of a 10% by weight aqueous solution of the initiator already used beforehand until full conversion has been attained. Thereafter, the reaction mixture is cooled down to room temperature (20-23° C.).

Table 1 lists synthesis examples for copolymers of component Z1) of the laundry detergent compositions of the invention.

TABLE 1
Substances used for preparation of the copolymers of component Z1)

| | V-PEG | PEG MA | | | | | Methacrylic | | Na hypo- | | | |
|---|---|---|---|---|---|---|---|---|---|---|---|---|
| Copolymer | 1100 | 1000 | AAPTAC | NIPAM | MAPTAC | DMAA | acid | AMPS | phosphite | MESNA | VA-44 | dist. H₂O |
| No. | [mmol] | [mmol] | [mmol] | [mmol] | [mmol] | [mmol] | [mmol] | [mmol] | [g] | [g] | [g] | [g] |
| 1 | 10.50 | 10.50 | 20.90 | — | — | — | — | — | — | 0.09 | 1.37 | 74.60 |
| 2 | 3.20 | 27.00 | 36.30 | — | — | — | — | — | 0.05 | — | 1.44 | 105.41 |
| 3 | 10.50 | 10.50 | — | — | 19.60 | — | — | — | — | 0.09 | 1.37 | 74.60 |
| 4 | 2.50 | 24.30 | 24.30 | 45.20 | — | — | 34.90 | — | — | 0.11 | 1.66 | 111.30 |
| 5 | 2.40 | 24.10 | 46.40 | — | — | — | — | 19.30 | 0.08 | — | 1.44 | 106.58 |
| 6 | 26.78 | — | 24.45 | — | — | 37.32 | — | — | — | 0.18 | 1.56 | 137.60 |

TABLE 1a
Relative amounts according to table 1

| | Total amount | | | | |
|---|---|---|---|---|---|
| | of the | | | | |
| | monomers | Structural | Structural | Structural | Structural |
| Copolymer | used | units (A) | units (B) | units (C) | units (D) |
| No. | [mmol] | [mol %] | [mol %] | [mol %] | [mol %] |
| 1 | 41.90 | 49.9 | 50.1 | — | — |
| 2 | 66.50 | 54.6 | 45.4 | — | — |
| 3 | 40.60 | 48.3 | 51.7 | — | — |
| 4 | 131.20 | 18.5 | 20.4 | 34.5 | 26.6 |
| 5 | 92.20 | 50.3 | 28.7 | 20.9 | — |
| 6 | 88.55 | 27.6 | 30.2 | 42.1 | — |

Measured weight-average molecular weights M_{w}:

| Copolymer | Weight-average |
|---|---|
| No. | molecular weight M_{w} |
| 1 | 3.25 × 10⁵ g/mol |
| 3 | 8.27 × 10⁴ g/mol |
| 4 | 1.07 × 10⁵ g/mol |

Laundry detergent compositions with illustrative copolymers

A number of illustrative laundry detergent compositions either with or without copolymer according to table 2 were produced. All the samples contain sodium hydroxide as a buffer system.

Key for the ingredients used in the compositions of table 2:

| | |
|---|---|
| LAS | linear C12-14-alkylbenzenesulfonate, sodium salt |
| SLES 2EO | sodium lauryl ether sulfate with 2 mol EO |
| | (Genapol ® LRO, Clariant) |
| NI 7EO | nonionic C12-15-alcohol ethoxylate 7EO |
| | (Genapol ® LA070, Clariant) |
| Fatty acid | stripped C12-18 palm kernel fatty acid |

TABLE 2
Laundry detergent compositions

| | % by weight of active substance | | | |
|---|---|---|---|---|
| Ingredient | 1 | 2 | 4 | 5 |
| LAS | 5.20 | 5.20 | 5.20 | 5.20 |
| SLES 2EO | 6.50 | 6.50 | 6.50 | 6.50 |
| NI 7EO | 5.20 | 5.20 | 5.20 | 5.20 |
| Fatty acid | 2.80 | 2.80 | 2.80 | 2.80 |
| Glycerol | 2.40 | 2.40 | 2.40 | 2.40 |
| Ethanol | 1.20 | 1.20 | 1.20 | 1.20 |
| Sodium citrate | 1.70 | 1.70 | 1.70 | 1.70 |
| Copolymer 1 | — | 1.00 | — | — |
| Copolymer 3 | — | — | 1.00 | — |
| Copolymer 4 | — | — | — | 1.00 |
| Demineralized water | ad 100 | ad 100 | ad 100 | ad 100 |
| and NaOH for | | | | |
| adjustment of pH | | | | |
| pH | 8.4 | 8.4 | 8.4 | 8.4 |
| Appearance at room | clear | clear | clear | clear |
| temperature | | | | |

Application Results

The laundry detergent compositions were tested for their secondary cleaning performance using a Lini apparatus. The conditions for the testing are listed in table 3.

TABLE 3
Wash conditions - application test

| Appliance | Linitest Plus (SDL Atlas) | |
|---|---|---|
| Water hardness | 14° | dH |
| Wash temperature | 40° | C. |
| Wash time | 30 | min |
| Laundry detergent concentration | 4.3 | g/L |

| | |
|---|---|
| Stained fabric:liquor ratio | 1:40 |
| Fabric | WFK10A |

The test fabric used was white standard cotton specimens (WFK 10A, from WFK Testgewebe GmbH). The fabrics were prewashed three times with the laundry detergent compositions. Then the specimens were rinsed, dried and stained with a sebum/carbon black mixture (5% by weight of carbon black). The stained specimens were left to dry for 24 hours, and then the color was measured according to the CIE-Lab scale using a MACH5 instrument (Color Consult, Holland) calibrated with a Datacolor 650 spectrophotometer. The specimens were then washed again with the same laundry detergent compositions as in the prewash step. After rinsing and drying of the washed specimens, another measurement of the color of the stain was conducted with the MACH5 instrument.

Since the color of the stained specimens was measured both before and after the wash step, it was possible to determine a value for ΔE:

$$Δ E = \sqrt{{( {L}_{before}^{*} - {L}_{after}^{*} )}^{2} + {( {a}_{before}^{*} - {a}_{after}^{*} )}^{2} + {( {b}_{before}^{*} - {b}_{after}^{*} )}^{2}}$$

The wash results obtained for the liquid laundry detergent compositions with the illustrative copolymers are shown in table 4.

TABLE 4
Washing performance of laundry detergent compositions from table 2

| Laundry detergent | | ΔE-ΔE (laundry detergent |
|---|---|---|
| composition from table 2 | ΔE | composition 1) |
| 1 (comparison) | 31.1 | — |
| 2 (invention) | 37.8 | 6.7 |
| 4 (invention) | 35.5 | 4.4 |
| 5 (invention) | 35.1 | 4.0 |

It can be inferred from the results in table 4 that the use of the copolymers of the invention in the laundry detergent formulation leads to significant lightening of the color of the stain, which confirms the soil release effect.

1. A laundry detergent composition comprising
Z1) at least one copolymer containing
a) 0.1 to 99.9 mol %, of at least one cationic structural unit (A) and
b) 0.1 to 99.9 mol %, of at least one macromonomeric structural unit (B),
wherein the at least one cationic structural unit (A) is represented by the following formulae (I) and/or (II): 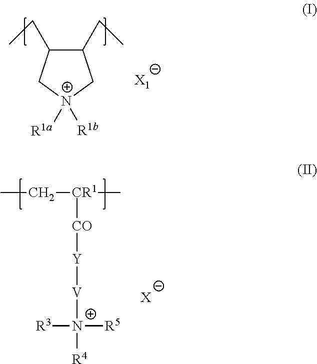
in which
R¹ and R^{1a} are each the same or different and are each independently hydrogen and/or a methyl radical,
R^{1b}, R³, R⁴ and R⁵ are each the same or different and are each independently represented by hydrogen, an aliphatic hydrocarbyl radical having 1 to 20 carbon atoms, a cycloaliphatic hydrocarbyl radical having 5 to 20 carbon atoms, an aryl radical having 6 to 14 carbon atoms and/or polyethylene glycol (PEG),
Y is the same or different and is represented by oxygen, NH and/or NR³,
V is the same or different and is represented by —(CH₂)ₓ—, 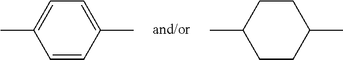
x is the same or different and is represented by an integer from 1 to 6,
X and X₁ are each the same or different and are each independently represented by a halogen atom, C₁- to C₄-alkylsulfate and/or C₁- to C₄-alkylsulfonate,
and the at least one macromonomeric structural unit (B) is represented by the formula (III): 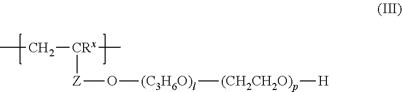
in which
R^{x} is the same or different and is represented by H and/or methyl,
Z is the same or different and is represented by C═O and/or O(CH₂)₄,
l on molar average is a number from 0 to 6, and
p on molar average is a number from 1 to 150,
and
Z2) at least one surfactant.

2. The laundry detergent composition as claimed in claim 1, wherein the at least one cationic structural unit (A) of the at least one copolymer of component Z1) is the polymerization product of at least one monomer species selected from the group consisting of [2-(acryloyloxy)ethyl]trimethylammonium chloride, [2-(acryloylamino)ethyl]trimethylammonium chloride, [2-(acryloyloxy)ethyl]trimethylammonium methosulfate, [2-(methacryloyloxy)ethyl]trimethylammonium chloride or methosulfate, [3-(acryloylamino)propyl]trimethylammonium chloride, [3-(methacryloylamino)propyl]trimethylammonium chloride and diallyldimethylammonium chloride (DADMAC).

3. The laundry detergent composition as claimed in claim 1, wherein the at least one macromonomeric structural unit (B) of the formula (III) of the at least one copolymer of component Z1) is the polymerization product of at least one monomer species selected from the group consisting of polyethylene glycol vinyloxybutyl ether, polyethylene glycol-co-polypropylene glycol vinyloxybutyl ether (in which I on molar average is a number from 1 to 6), polyethylene glycol (meth)acrylate and polyethylene glycol-co-polypropylene glycol (meth)acrylate (in which I on molar average is a number from 1 to 6).

4. The laundry detergent composition as claimed in claim 1, wherein, in the at least one macromonomeric structural unit (B) of the formula (III) of the at least one copolymer of component Z1),
i) R^{x} is H, I=0 and p on molar average is a number from 1 to 150, when Z is O(CH₂)₄ or
ii) R^{x} is the same or different and is represented by H and/or methyl, I on molar average is a number from 1 to 6, and p on molar average is a number from 1 to 150, when Z is C═O.

5. The laundry detergent composition as claimed in claim 1, wherein the at least one copolymer of component Z1), in addition to the structural units (A) and (B), further contain at least one structural unit (C) which differs from the structural units (A) and (B), and where the at least one copolymer contains
preferably 0.1 to 99.8 mol % of the at least one structural unit (A), 0.1 to 99.8 mol % of the at least one structural unit (B) and 0.1 to 99.8 mol % of at least one structural unit (C).

6. The laundry detergent composition as claimed in claim 5, wherein the at least one structural unit (C) of the at least one copolymer of component Z1) is the polymerization product of at least one monomer species selected from the group consisting of noncationic acrylamides, noncationic methacrylamides and N-vinyl-substituted lactams having 5 to 7 ring atoms.

7. The laundry detergent composition as claimed in claim 5, wherein the at least one structural unit (C) of the at least one copolymer of component Z1) is selected from the group consisting of the polymerization product of at least one N-vinyl-substituted lactam having 5 to 7 ring atoms and the structural units of the following formulae (IV) and (V): 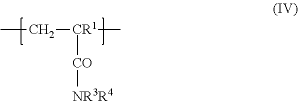
in which
R¹ is the same or different and is hydrogen and/or methyl, and
R³ and R⁴ are each the same or different and are each independently represented by hydrogen, an aliphatic hydrocarbyl radical having 1 to 20 carbon atoms, a cycloaliphatic hydrocarbyl radical having 5 to 20 carbon atoms, an aryl radical having 6 to 14 carbon atoms, an alkylaryl radical having 7 to 14 carbon atoms, a branched or unbranched C₁-C₅-monohydroxyalkyl group and/or polyethylene glycol (PEG), 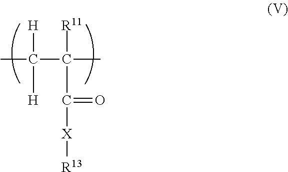
in which
R¹¹ is the same or different and is represented by H and/or methyl;
X is the same or different and is represented by NH—(CₙH₂ₙ) with n=1, 2, 3 or 4; and
R¹³ is the same or different and is represented by OH, N(CH₃)₂, SO₃H, PO₃H₂, O—PO₃H₂ and/or para-substituted C₆H₄—SO₃H.

8. The laundry detergent composition as claimed in claim 7, wherein the at least one structural unit (C) of the at least one copolymer of component Z1) is selected from the group consisting of structural units of the formula (IV).

9. The laundry detergent composition as claimed in claim 5, wherein the at least one structural unit (C) of the at least one copolymer of component Z1) is the polymerization product of at least one monomer species selected from the group consisting of acrylamide, methacrylamide, N-methylacrylamide, N,N-dimethylacrylamide, N-ethylacrylamide, N-cyclohexylacrylamide, N-benzylacrylamide.

10. The laundry detergent composition as claimed in claim 1, wherein the at least one copolymer of component Z1), in addition to the structural units (A), (B) and (C), further contains at least one structural unit (D) which differs from the structural units (A), (B) and (C), and where the at least one copolymer contains 0.1 to 99.7 mol % of the at least one structural unit (A), 0.1 to 99.7 mol % of the at least one structural unit (B), 0.1 to 99.7 mol % of the at least one structural unit (C) and 0.1 to 99.7 mol % of the at least one structural unit (D).

11. The laundry detergent composition as claimed in claim 10, wherein the at least one copolymer of component Z1) contains at least one structural unit (D) selected from the group consisting of structural units of the following formula (VII): 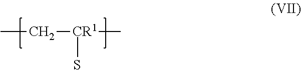
in which
S is the same or different and is represented by —COOMₖ,
R¹ is the same or different and is represented by H and/or an unbranched or branched C₁-C₄-alkyl group; and
M is a cation selected from the group consisting of hydrogen ion, alkali metal ion and alkaline earth metal ion, with k=valency.

12. The laundry detergent composition as claimed in claim 11, wherein the at least one copolymer of component Z1) contains at least one structural unit (D) that is the polymerization product of at least one monomer species selected from the group consisting of acrylic acid, sodium acrylate, potassium acrylate, methacrylic acid, sodium methacrylate and potassium methacrylate.

13. The laundry detergent composition as claimed in claim 1, wherein the structural units (A), (B) and optionally (C) and (D) of the at least one copolymer of component Z1) is present in the copolymer in a random, blockwise, alternating or gradient distribution.

14. The laundry detergent composition as claimed in claim 1, wherein the weight-average molecular weight Mw of the at least one copolymer of component Z1) is from 10 000 to 400 000 g/mol.

15. The laundry detergent composition as claimed in claim 1, wherein the at least one surfactant of component Z2) is selected from the group consisting of anionic, nonionic, amphoteric and cationic surfactants.

16. The laundry detergent composition as claimed in claim 15, wherein the at least one surfactant of component Z2) is selected from the group consisting of fatty alcohol polyglycol ethers, alkyl polyglycosides, alkylbenzenesulfonates, alkanesulfonates, alkyl ether sulfates, alkyl sulfates, glucamides, amine oxides, betaines and quaternary ammonium compounds.

17. The laundry detergent composition as claimed in claim 1, which comprises, in addition to the at least one copolymer of component Z1) and the at least one surfactant of component Z2), at least one further substance selected from the group consisting of components Z3), Z4), Z5), Z6) and/or Z7):
Z3) at least one complexing agent as component Z3),
Z4) at least one solvent other than water as component Z4),
Z5) at least one further additive,
Z6) water as component Z6),
Z7) at least one builder as component Z7).

18. The laundry detergent composition as claimed in claim 1, which comprises the at least one copolymer of component Z1) in an amount of 0.0005% to 10.0% by weight, on the total weight of the laundry detergent composition.

19. The laundry detergent composition as claimed in claim 1, which comprises
Z1) 0.0005% to 10.0% by weight of component Z1), and
Z2) 0.1% to 60.0% by weight of component Z2),
based in each case on the total weight of the laundry detergent composition.

20. A method for cleaning of a textile comprising the step on contacting the textile with the laundry detergent composition as claimed in claim 1.

21. A method for reducing the restaining of a textile comprising the step on contacting the textile with the laundry detergent composition as claimed in claim 1.
